(19) United States
(12) Patent Application Publication
(10) Pub. No.: US 2006/0237216 A1
(43) Pub. Date: Oct. 26, 2006

(54) Covering member and method of manufacturing the same

(75) Inventors: Yoshikazu Yoshida, Nisshin-shi (JP); Kazuo Andoh, Sakado-shi (JP); Masao Idei, Kitamoto-shi (JP); Shinji Kono, Kusatsu-shi (JP)

Correspondence Address: COOPER & DUNHAM, LLP, 1185 AVENUE OF THE AMERICAS, NEW YORK, NY, 10036, US

(73) Assignee: Toyo Quality One Corporation

(21) Appl. No.: 11/473,583

(22) Filed: Jun. 22, 2006

Related U.S. Application Data
(63) Continuation of application No. PCT/JP04/19657, filed on Dec. 21, 2004.

(30) Foreign Application Priority Data
Dec. 25, 2003 (JP) 2003-431097

(51) Int. Cl. H01B 3/30

(52) U.S. Cl. 174/110 R; 174/102 SP; 385/136

(57) ABSTRACT

Disclosed is a covering member comprising a cylindrical foam or a columnar foam including a cut consisting of a slit line which extends from the outer circumferential surface of the foam to reach a through-hole of the foam, wherein the slit line joining the open portion formed by the cut on the outer circumferential surface of the foam to the open portion formed by the cut on the inner circumferential surface of the foam is nonlinear in respect of the cross section of the covering member in a direction perpendicular to the axial direction of the foam.

### TECHNICAL FIELD

The present invention relates to a covering member used as a buffer member, as a heat insulating member, or as a protective member and to the method of manufacturing the same. To be more specific, the present invention relates to a covering member used as buffer member for preventing the generation of an odd sound or noise when a wire cable used in, for example, a part of an automobile such as a hood, a door lock, a gasoline supply port or a damper switch is vibrated so as to be brought into contact with the vehicle body. The covering member of the present invention is also used as a heat insulating member or as a protective member of various daily life pipes, facilities pipes, and support rods.

### BACKGROUND ART

When it comes to the conventional vehicle such as an automobile, a wire cable is widely used in a hood, a door lock, a gasoline support port, and a damper switch. As a measure against the generation of an odd sound or noise, a cylindrical buffer member is used in the wire cable. Also, a cylindrical heat insulating member and a cylindrical protective member are used for the purpose of the heat insulation and the protection in the daily life pipes such as a city water pipe, in cords of an air conditioner and in support rods in the park or the athletic field. Known is a buffer member constituting a covering member of the present invention, which is constructed as shown in, for example, FIG. 5. The conventional covering member of this type is obtained by punching a flat sheet foam such that the punched cylindrical foam includes a through-hole formed in the central portion (former type) or by extruding a rubber foam such that the extruded rubber foam includes a through-hole formed in the central portion (latter type).

As shown in the drawing, a cylindrical buffer member 41 includes a through-hole 43 extending in the axial direction in the central portion of a cylindrical body 42. The buffer member of the particular construction, which is mounted in advance to a wire cable, is incorporated in a vehicle body. However, the buffer member of the type shown in FIG. 5 is incapable of coping with the difficulty in the case where an inconvenience such as generation of an odd sound (noise) has taken place in the vehicle after incorporation of the wire cable in the vehicle body so as to make it necessary to newly mount the buffer member.

It should also be noted that, in the former type in which the buffer member is prepared from a thick flat sheet foam (the thickness of the foam corresponding to the length of the buffer member) by a punching method, the waist portion of the punched buffer member is deformed so as to be made thin as shown in FIG. 6. As a result, the maximum thickness of the foam that can be punched for preparation of the buffer member is limited to about 100 to 150 mm. In other words, the maximum length of the buffer member prepared by the punching method is limited to about 100 to 150 mm. On the other hand, in the latter type in which the buffer member is prepared by the extrusion method, it is certainly possible to eliminate the difficulty noted above in respect of the length of the buffer member. In this case, however, it is difficult to insert the wire cable into the buffer member, so it is necessary to insert the wire cable into the buffer member while swelling the buffer member by blowing the air. Such being the situation, the extrusion method gives rise to the problem that the maximum length of the manufactured buffer member is substantially limited to about 200 mm. Attentions should also be paid to the problem inherent in both the buffer member prepared by the punching method and the buffer member prepared by the extrusion method. For example, attentions should be paid to the wire cable equipped with a casing cap, which is a male cap for setting a wire cable in the vehicle body. In some cases, the casing cap has a diameter larger than the central through-hole diameter in the axial direction of the buffer member. What should be noted is that it is impossible to mount the buffer member of the type shown in FIG. 5 to the wire cable equipped with the large casing cap noted above even before the mounting of the wire cable to the vehicle body.

A buffer member 51 constructed as shown in FIG. 7 has been developed in an attempt to overcome the difficulty noted above. As shown in the drawing, the buffer member 51 includes a slit 54 extending in the axial direction of a cylindrical body 52. The slit 54 also extends in the radial direction from the outer circumferential surface of the cylindrical body 52 to reach a through-hole 53 formed in the central portion of the cylindrical body 52. In other words, the open portion 55 formed by the slit 54 on the outer circumferential surface of the cylindrical body 52 is joined to the open portion 56 formed by the slit 54 on the inner circumferential surface of the cylindrical body 52 by a single straight line, as shown in the drawing. A buffer member of the type that a flat sheet foam is wound in an annular shape has also been developed as a buffer member that can be mounted later to a wire cable. In the buffer member of these type, however, it was necessary to fasten the outer circumferential portion of the buffer member with a binding band or to use an adhesive so as to prevent the cylindrical body or the flat sheet foam from coming off from the wire cable. In addition, it was possible for the adhesive to be melted during the use of the buffer member under a high temperature so as to give rise to the problem that the buffer member is came off.

On the other hand, with the tendency in recent years toward the elimination of the noise of the vehicle, the buffer member has come to be mounted over the entire length of the wire cable in many cases. In such a case, a plurality of cylindrical buffer members each having a length of 200 mm are joined to each other.

It should also be noted that, in these conventional buffer members, the core of the buffer member tends to be torn off in the process of taking out the core for forming the through-hole in the central portion of the buffer member. Particularly, much labor was required for removing the core when it comes to the buffer member for a thin wire cable, said buffer member having the core having 1 to 3 mm of the diameter.

Under the circumstances, it was of high importance to develop a buffer member, which is unlikely to come off even if an adhesive or a binding band is not used, which is possible to mount to the wire cable in the subsequent step, which facilitates the operation to remove the core, which is not deformed in the constricted shape in the waist portion even if the buffer member is long, and which can be mounted easily to, for example, a wire cable.

Patent document 1 given below, which relates to a noise preventing member that is mounted to a grommet, teaches an apparatus comprising a cylindrical foam provided with a hole for inserting a wire harness or with a slit for inserting a wire harness, an annular plate member that is fixed to one edge surface of the cylindrical foam, and a wire harness holding member including a long tongue section protruding from a part of the inner circumferential edge of the annular plate member. It is taught that the wire harness is inserted into the through-hole of the cylindrical foam, with the wire harness holding member wound with a tape or fastened by a band.

Patent Document 1: Japanese Patent Disclosure (Kokai) No. 9-46863

### DISCLOSURE OF INVENTION

An object of the present invention, which has been achieved in view of the situation described above, is to provide a covering member, which is unlikely to come off even if an adhesive or a binding band is not used and which is possible to mount separately in the subsequent step to, for example, a wire cable.

Another object of the present invention is to provide a method of manufacturing a covering member, which permits facilitating the operation to remove the core, which permits manufacturing a covering member that is not deformed in the constricted shape in the waist portion even if the covering member is long, and which permits facilitating the mounting of the covering member to, for example, a wire cable.

According to an aspect of the present invention, there is provided a covering member comprising a cylindrical foam or a columnar foam and a cut permitting a slit line to extend from the outer circumferential surface of the foam to reach a through-hole of the foam, wherein the slit line joining the open portion formed by the cut on the outer circumferential surface of the foam to the open portion formed by the cut on the inner circumferential surface of the foam is nonlinear in respect of the cross section of the covering member in a direction perpendicular to the axial direction of the foam.

Also, according to another aspect of the present invention, there is provided a method of manufacturing a covering member comprising a cylindrical foam or a columnar foam including cut consisting of a slit line which extends from the open portion on the outer circumferential surface of the foam to reach the open portion on a through-hole of the foam, wherein the foam is cut by a two dimensional cutting machine so as to consist of the slit line joining the open portion formed by the cut on the outer circumferential surface of the foam to the open portion formed by the cut on the inner circumferential surface of the foam to be nonlinear in respect of the cross section of the covering member in a direction perpendicular to the axial direction of the foam.

In the covering member of the present invention, the foam consists of, for example, a polyurethane foam.

According to the covering member of the present invention, the cut of the construction described above is formed consisting of the slit line to appear on the cylindrical foam or the columnar foam so as to make it possible to obtain a covering member, which is unlikely to come off even if an adhesive or a binding band is not used as in the prior art, and which is possible to mount to, for example, a wire cable in the subsequent step.

It should also be noted that, the covering member of the present invention is manufactured by using a two dimensional cutting machine so as to facilitate the operation to remove the core from the covering member and, thus, to obtain a covering member, which is free from the deformation of the waist portion in a constricted shape even if the covering member is long, and which facilitates the mounting of the covering member to, for example, a wire cable.

### BRIEF DESCRIPTION OF DRAWINGS

FIG. 1 is a cross sectional view showing the construction of a buffer member for Example 1 of the present invention;

FIG. 2 is a cross sectional view showing the construction of a buffer member for Example 2 of the present invention;

FIG. 3 is a cross sectional view showing the construction of a buffer member for Example 3 of the present invention;

FIG. 4 is an oblique view showing the construction of a buffer member of the present invention, which is cut out in a large number by a two dimensional cutting machine;

FIG. 5 is an oblique view showing the construction of the conventional buffer member;

FIG. 6 is an oblique view showing the modification of a conventional buffer member prepared by the punching from a thick foam;

FIG. 7 is an oblique view showing the construction of a conventional buffer member, which has been improved;

FIG. 8 is a cross sectional view showing the construction of a covering member according to an embodiment of the present invention, said covering member including two through-hole;

FIG. 9 is a cross sectional view showing the construction of a buffer member for Example 4 of the present invention;

FIG. 10 shows the state that the buffer member shown in FIG. 9 is mounted to a cable in a bent shape;

FIG. 11 is a cross sectional view showing the construction of a buffer member for Comparative Example 1; and

FIG. 12 shows the state that the buffer member shown in FIG. 11 is mounted to a cable in a bent shape.

### BEST MODE FOR CARRYING OUT THE INVENTION

The present invention will now be described in detail with reference to the accompanying drawings.

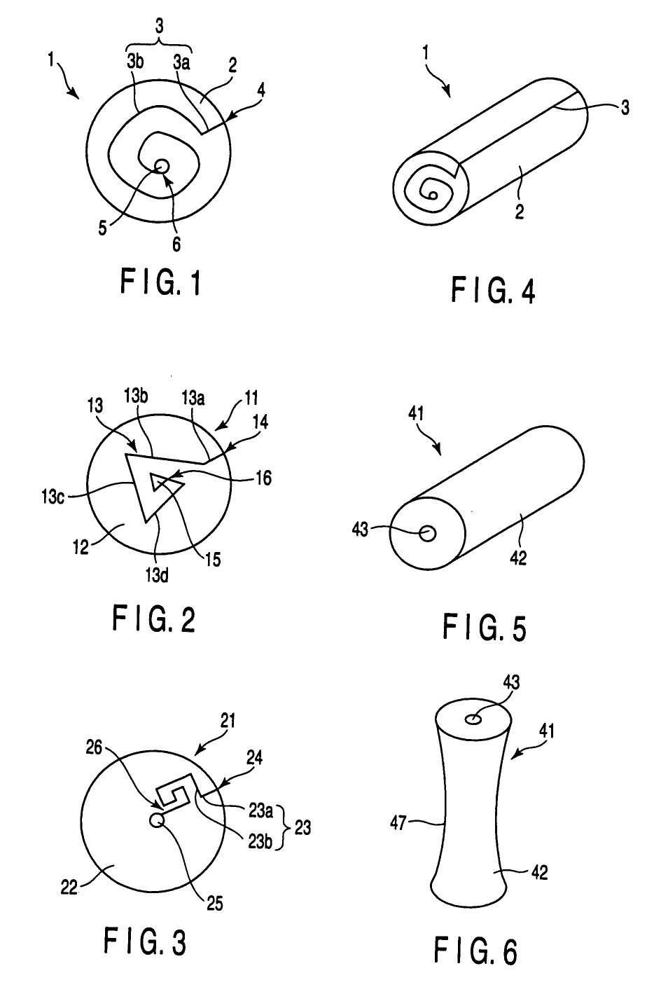

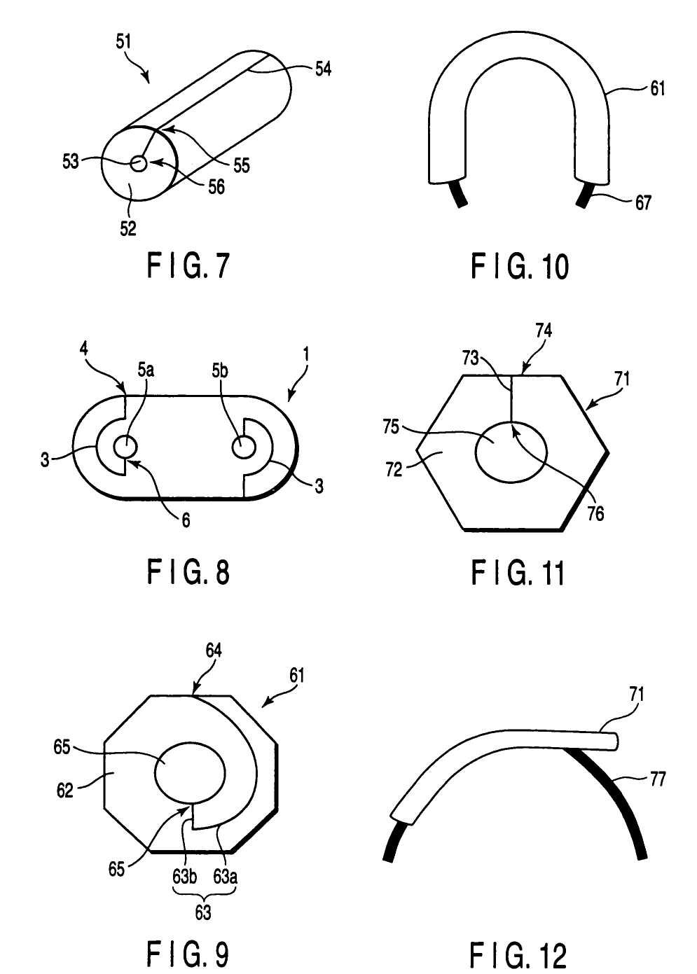

It is characterized in the present invention that the slit line joining the open portion formed by the cut on the outer circumferential surface of the cylindrical foam or the columnar foam to the open portion formed by the cut on the inner circumferential surface of the foam is non linear. This means that the open portion formed by the cut on the outer circumferential surface of the foam and the open portion formed by the cut on the inner circumferential surface of the foam is not joined to each other by a single straight slit line. To be more specific, the slit line defined in the appended claims includes a spiral slit line consisting of curved slit lines alone, a slit line consisting of a curved slit line and a straight slit line as shown in FIG. 1, and a slit line consisting of a plurality of straight slit lines as shown in FIGS. 2 and 3.

In the present invention, the covering member including a cut of the construction described above, which is formed to consist of the slit line to appear on the cross section of a cylindrical foam or a columnar foam, can be obtained by using a processing facility known to the art. For example, it is possible to manufacture the covering member of the present invention by the method using a punching machine including a mold equipped with a blade corresponding to a desired cut or by the method using a two dimensional cutting machine such as a contour cutting machine or a boimel processor. The covering member including the particular cut can be spread open so as to facilitate the operation to remove the core and to facilitate the mounting of the covering member to, for example, a wire cable.

Particularly, it is possible to obtain a large covering member having a length of about 2,000 mm by using a two dimensional cutting machine such as a contour cutting machine, though the length of the covering member that is obtained depends on the size of the cutting machine. It follows that it is possible to cut the long covering member into a plurality of pieces of the covering members each having a desired length in accordance with the mounting position of the covering member. Of course, the waist portion of the covering member having a desired length is not deformed in a constricted shape.

The covering member of the present invention comprises a cylindrical foam or a columnar foam. The cylindrical foam denotes a foam having the core removed therefrom so as to form a through-hole in the central portion of the foam such that the through-hole extends in the axial direction of the foam. On the other hand, the columnar foam denotes a foam simply having a cut and having the core not removed therefrom. It is possible to select appropriately the cylindrical covering member or the columnar covering member depending on, for example, the wire cable to which the covering member is mounted. For example, where the wire cable to which the covering member is mounted is thin, selected is the columnar covering member from which the core is not removed. In any case, the kind of the covering member that is used is determined in view of, for example, the number of wire cables, the hardness of the foam, etc. It is also possible to use a covering member having a plurality of through-hole 5a, 5b as shown in FIG. 8. Also, it is possible for the cross sectional shape of the covering member to be circular or polygonal such as pentagonal, as shown in FIGS. 1 to 4. Incidentally, the through-hole is formed in general in the central portion of the foam. However, it is not absolutely necessary for the through-hole to be positioned in the central portion as shown in FIG. 8.

In the present invention, it is possible to use a known material for forming the cylindrical or columnar foam. For example, it is possible to use a rubber foam or various foamed resins such as a polyethylene foam and a polypropylene foam. Particularly, it is desirable to use a polyurethane foam for forming the cylindrical or columnar foam because the polyurethane foam exhibits an excellent flexibility, is light in weight, and is low in cost. It should also be noted that the polyurethane foam is less likely to be slid than the other foamed resins. As a result, the covering member comprising the polyurethane foam is unlikely to come off from the mounted position after the covering member is mounted to, for example, a wire cable, even if an adhesive or a binding band is not used. Also, the particular covering member is scarcely deviated from the desired position. Needless to say, however, it is possible to use an adhesive or a binding band in the case where a severe vibration or an impact is expected and it is considered desirable to use the adhesive or the binding band.

As described previously, the covering member of the present invention including a cut that comprises a slit line to appear on the cross section of the cylindrical or columnar foam. The cut forms a nonlinear slit line between the open portion formed by the cut on the outer circumferential surface of the foam and the open portion formed by the cut on the inner circumferential surface of the foam. The particular construction makes it possible to spread the cylindrical or columnar foam from the cut in the axial direction. It follows that the covering member can be mounted to a wire cable in a manner to wind the covering member around the wire cable. Such being the situation, the covering member of the present invention can be mounted to the wire cable after the wire cable is incorporated in a vehicle body. It is also possible to mount easily the covering member of the present invention to a wire cable equipped with a casing cap having a diameter larger than the through-hole included in the covering member. In addition, since a large covering member can be obtained easily by the processing with a two dimensional cutting machine, it is possible to mount easily the covering member over the entire length of the wire cable while eliminating the troublesome operation of joining a plurality of short covering members to each other as in the prior art. Of course, it is also possible to insert simply the wire cable into the through-hole of the covering member as in the prior art in place of winding the covering member around the wire cable.

It should also be noted that, where the flat sheet foam is forcedly bent into an annular shape for the fixation as in the prior art, the stress to bring the foam itself back to the original shape is generated so as to cause the covering member to be come off easily from the mounted position. In the covering member of the present invention, however, a cut is formed in the cylindrical or columnar foam, with the result that an extra stress is not generated under the state that the covering member is mounted to the wire cable. It follows that the covering member of the present invention provides a buffer member that is unlikely to be come off from the mounted position even if an adhesive or a binding band is not used.

Examples of the present invention will now be described.

### EXAMPLE 1

FIGS. 1 and 4 show the construction of the buffer member for this Example. A reference numeral 1 shown in the drawings denotes a buffer member. The buffer member 1 comprises a cylindrical foam 2 consisting of a polyurethane foam and a cut 3 consisting of a spiral slit line to appear on the cross section of the cylindrical foam 2. As shown in FIG. 1, the cut 3 (or the slit line) extends from the open portion 4 on the outer circumferential surface of the foam 2 so as to reach the open portion 6 on the inner circumferential surface of the foam 2, i.e., to reach a through-hole 5 positioned in the central portion of the foam 2 and extending in the axial direction of the foam 2. Also, the cut 3 (or the slit line) includes a straight slit line portion 3a and a curved slit line portion 3b.

The buffer member 1 was manufactured as follows. Specifically, 2030 buffer members 1 each sized at 16 mm in the diameter, at 2200 mm in the length, and at 5 mm in the diameter of the core portion were cut out by using a Boimel processing machine (type number of OFS-222CNC, manufactured by BÄUMER inc.) from a polyurethane foam having a density of 16 kg/m³ and a hardness of 68N, said polyurethane foam being sized at 1200 mm×2200 mm×550 mm. Then, the core portion of the buffer member was easily removed by opening the buffer member from the cut section.

The buffer member 1 according to Example 1 is constructed to include the spiral cut 3 (spiral slit line) that appears on the cross section of the cylindrical foam 2 consisting of a polyurethane foam. Because of the particular construction, it is possible to mount the buffer member 1 in a manner to wind a wire cable wound around the buffer member 1. It follows that an extra stress is not generated in the buffer member 1 wound around the wire cable, with the result that the buffer member 1 is not came off from the mounted position even if an adhesive or a binding band is not used for mounting the buffer member 1.

Also, the buffer member 1 can be mounted easily to the wire cable after the wire cable is incorporated in a vehicle body or to the wire cable equipped with a casing cap. Further, it is possible to mount easily the buffer member 1 over the entire length of the wire cable while eliminating the troublesome operation of joining a plurality of short covering members to each other as in the prior art.

### EXAMPLE 2

FIG. 2 shows the construction of the buffer member for this Example. A reference numeral 11 shown in the drawing denotes a buffer member. The buffer member 11 comprises a cylindrical foam 12 consisting of a polyurethane foam and a cut 13 consisting of a slit line to appear on the cross section of the cylindrical foam 12. As shown in FIG. 2, the cut 13 (slit line) extends from the open portion 14 on the outer circumferential surface of the foam 12 to reach the open portion 16 on the inner circumferential surface of the foam 12, i.e., to reach a through-hole 15 formed to extend in the axial direction of the foam 12. The cut 13 (slit line) consists of a plurality of linear cut (slit line) sections 13a, 13b, 13c, 13d, 13e, 13f and 13g.

The buffer member 11 for Example 2 produces the effects similar to those produced by the buffer member 1 for Example 1.

### EXAMPLE 3

FIG. 3 shows the construction of the buffer member for this Example. A reference numeral 21 shown in the drawing denotes a buffer member. The buffer member 21 comprises a cylindrical foam 22 consisting of a polyurethane foam and a cut 23 consisting of a slit line to appear on the cross section of the cylindrical foam 22. As shown in FIG. 3, the cut 23 (slit line) extends from the open portion 24 on the outer circumferential surface of the foam 22 so as to reach the open portion 26 on the inner circumferential surface of the foam 22, i.e., to reach a through-hole 25 formed to extend in the axial direction of the foam 22. The cut 23 (slit line) consists of a plurality of linear cut (slit line) sections 23a, 23b, etc.

The buffer member 21 for Example 3 produces the effects similar to those produced by the buffer member 1 for Example 1.

### EXAMPLE 4

FIG. 9 shows the construction of the buffer member for this Example. A reference numeral 61 shown in the drawing denotes a buffer member. The buffer member 61 comprises a cylindrical foam 62 consisting of a polyurethane foam. The foam 62 has an octagonal cross sectional shape having a diagonal of 16 mm and includes a through-hole 65 having a diameter of 4 mm. Also, a cut 63 (slit line) is formed in the foam 62. It should be noted that the cut 63 (slit line) appearing on the cross section of the foam 62 consists of a curved cut (slit line) section 63a and a straight cut (slit line) section 63b in order to compose the cut 63 (slit line) to extend from the open portion 64 on the outer circumferential surface of the foam 62 so as to reach the open portion 66 on the inner circumferential surface of the foam 62, i.e., to reach the through-hole 65 formed to extend in the axial direction of the foam 62.

The buffer member for Example 4 produces the effects similar to those produced by the buffer member for Example 1. As a matter of fact, the buffer member was mounted to a cable, with the length of the buffer member, which was constructed as shown in FIG. 9, changed to 200 mm, 150 mm and 100 mm, so as to examine the situation as to how the buffer member, which was bent to about 40 R, would be came off from the cable. The cable had an outer diameter of 4φ and was formed of polypropylene (PP). Also, a wire was put inside the cable, which was tubular. The buffer member 61 was found not to be came off from the cable 67 as shown in FIG. 10 even in the case where the buffer member had a length of 200 mm. Incidentally, the buffer member was not came off from the cable in the case where the buffer member had a length of 150 mm or 100 mm.

### COMPARATIVE EXAMPLE

FIG. 11 shows the construction of the covering member for this Comparative Example. A reference numeral 71 shown in the drawing denotes a buffer member. The buffer member 71 comprises a cylindrical foam 72 consisting of a polyurethane foam. The foam 72 has an octagonal cross sectional shape having a diagonal of 16 mm and includes a through-hole 75 extending in the axial direction of the foam 72 and having a diameter of 4 mm. Also, a cut 73 (slit line) is formed in a manner to form a single straight slit line crossing the cross section of the foam 72. The cut 73 (slit line) is formed to extend from the open portion 74 on the outer circumferential surface of the foam 72 so as to reach the open portion 76 on the inner circumferential surface of the foam 72, i.e., to reach the through-hole 75 of the foam 72.

A bending test similar to that for Example 4 was also applied to the buffer member for the Comparative Example. The buffer member was found to have come off from the cable before the bending degree of the buffer member reached 40 R in each of the cases where the buffer member had a length of 200 mm, 150 mm and 100 mm. FIG. 12 shows the came off state of the buffer member 71 from the cable 77, covering the case where the buffer member had a length of 200 mm.

In each of the Examples described above, the density and the hardness of the polyurethane foam were set at optional values. However, it is possible to change the values of the density and the hardness of the polyurethane foam appropriately so as to be adapted for the environment under which the buffer member is actually used. Further, it is possible to select appropriately the foam capable of withstanding the environment under which the foam is actually used. For example, it is possible to select the foam having an appropriate heat resistance, weatherability, and water sealing capability.

Also, the present invention is not limited to the Examples described above. It is possible to modify the covering member of the present invention in actually working the invention without departing from the technical scope of the present invention.

### INDUSTRIAL APPLICABILITY

As described above, the present invention provides a covering member, which is not came off even if an adhesive or a binding band is not used, and which can be mounted later to, for example, a wire cable separately.

It should also be noted that, since it is unnecessary to use an adhesive for mounting the covering member of the present invention to, for example, a wire cable, it is unnecessary to worry about the problem that the adhesive is melted during use of the covering member under a high temperature. It follows that the covering member of the present invention is highly effective when used under a high temperature environment, e.g., when used in the region around the engine.

Also, the manufacturing method of the present invention permits facilitating the operation to remove the core so as to make it possible to provide a covering member, which is not deformed in its waist portion in a constricted shape and which can be mounted easily to, for example, a wire cable. It should also be noted that, by using the long covering member obtained by the manufacturing method of the present invention, it is possible to eliminate the troublesome operation to join a plurality of short covering members to each other as in the prior art. It follows that it is possible to improve markedly the efficiency of the operation to mount the covering member to the wire cable.

Incidentally, the Examples described above are directed to a buffer member for a part of the vehicle. However, the use of the covering member of the present invention is not particularly limited.

Also, the present invention is not limited to the above. It is possible to modify the constituents of the present invention in actually working the invention without departing from the technical scope of the present invention. Further, it is possible to achieve various inventions by combining appropriately a plurality of constituents of the present invention disclosed herein in conjunction with the embodiment of the present invention. For example, it is possible to delete some constituents from all the constituents disclosed herein in conjunction with the embodiment of the present invention. Further, it is possible to combine the constituents belonging to different embodiments of the present invention.

1. A covering member comprising a cylindrical foam or a columnar foam including a cut consisting of a slit line which extends from the outer circumferential surface of the foam to reach a through-hole of the foam, wherein the slit line joining the open portion formed by the cut on the outer circumferential surface of the foam to the open portion formed by the cut on the inner circumferential surface of the foam is nonlinear in respect of the cross section of the covering member in a direction perpendicular to the axial direction of the foam.

2. The covering member according to claim 1, wherein the cut has a spiral cross sectional slit line.

3. The covering member according to claim 1, wherein the cylindrical foam or the columnar foam is formed of a polyurethane foam.

4. The covering member according to claim 1, wherein the cylindrical foam or the columnar foam is formed of a polyurethane foam, and the cut has a spiral cross sectional slit line.

5. A method of manufacturing a covering member comprising a cylindrical foam or a columnar foam including a cut consisting of a slit line which extends from the open portion on the outer circumferential surface of the foam to reach the open portion on a through-hole of the foam, wherein the foam is cut by a two dimensional cutting machine so as to consist of the slit line joining the open portion formed by the cut on the outer circumferential surface of the foam to the open portion formed by the cut on the inner circumferential surface of the foam to be nonlinear in respect of the cross section in a direction perpendicular to the axial direction of the foam.
